(19) United States
(12) Patent Application Publication
(10) Pub. No.: US 2012/0284435 A1
(43) Pub. Date: Nov. 8, 2012

(54) ZONE GROUP MANAGER VIRTUAL PHY

(76) Inventors: Michael G. Myrah, Tomball, TX (US); Balaji Natrajan, Houston, TX (US); Sohail Hameed, Houston, TX (US)

(21) Appl. No.: 13/099,851

(22) Filed: May 3, 2011

(51) Int. Cl. G06F 13/10

(52) U.S. Cl. 710/74

(57) ABSTRACT

A switch is provided. The switch includes an expander configured to couple a server to a set of storage drive bays. The switch also includes a zone manager coupled to the expander and configured to maintain a zoning configuration corresponding to the set of storage drive bays. The zone manager is coupled to the expander through a virtual PHY.

### BACKGROUND

Direct-attached storage (DAS) refers to a data storage system that is directly attached to a server or workstation. The data capacity and connectivity of the DAS system may be improved through the use of switches or expanders, which enable a large bank of DAS devices to be coupled to multiple servers. A common communications protocol for enabling communications between the servers and the storage drives is the serial attached small computer system interface (SAS). SAS devices such as storage controllers, storage drives, and expanders communicate with each other using the SAS protocol. The interconnection network between the SAS devices may be referred to as a fabric.

The storage resources of the DAS devices are made accessible to servers by configuring zone groups, which control how the expanders route connections through the switch to couple specific servers to specific storage drive bays. Zoning operations and SAS fabric device discovery can be performed by a zone manager entity that resides on the SAS switch. The zone manager may be connected to an expander on the switch through a network connection such as Ethernet or implemented as a function of the SAS switch expander. However, the zone manager is typically not a SAS device and cannot be discovered by any of the other SAS devices in the DAS system.

### BRIEF DESCRIPTION OF THE DRAWINGS

Certain exemplary embodiments are described in the following detailed description and in reference to the drawings, in which:

FIG. 1 is a block diagram of a DAS system in accordance with embodiments;

FIG. 2 is a process flow diagram of a method of operating a zone manager virtual PHY in accordance with embodiments;

FIG. 3 is a process flow diagram of a method of operating a zone manager virtual PHY in accordance with embodiments; and

FIG. 4 is a block diagram showing a non-transitory, computer-readable medium that stores code for operating a zone manager virtual PHY in accordance with embodiments.

### DETAILED DESCRIPTION OF SPECIFIC EMBODIMENTS

Embodiments of the present techniques provide a system and a method for zone management in a DAS (Direct Attached Storage) system. More specifically, embodiments of the present techniques provide a zone manager virtual PHY (ZMVP) on a SAS switch expander. In this way, the SAS switch zone manager can communicate with other devices in the SAS fabric using in-band standards-based SAS discovery and communication mechanisms as though the zone manager was an actual SAS-based end device.

Several advantages may be realized by implementing a zone manager virtual PHY on the SAS switch expander. For example, when designing a SAS switch, the number of SAS ports desired by the customer is generally weighed against the material costs and hardware complexity of routing the SAS lanes for those ports to the switch expanders. In most cases, a 16 port SAS switch will be sufficient for most users, but there may be some users that would prefer to have a 32 or even 48 port SAS switch. However, designing a 48 port switch will add cost to the majority of users who will not use the additional ports. Similarly, designing and maintaining two or more switches with different numbers of ports would also add cost. To satisfy a broad range of user configurations, a single 16 port SAS switch can be developed, and the SAS fabric can be scaled for larger storage capacity configurations by coupling additional 16 port switches on to the first switch in a “trunking” or “daisy chain” configuration. Trunking is accomplished by connecting a SAS cable from the first SAS switch to the next SAS switch.

When implementing SAS switch trunking, the design complexity of the SAS fabric can be reduced by enabling a single zone manager to control the entire SAS fabric, even across multiple trunked SAS switches, each of which includes its own zone manager. In such a system, a single zone manager may be active, while all other zone managers may be passive. In order for one SAS switch zone manager to be active while all others are passive, an inter-switch arbitration process between the zone managers may be implemented. Because the typical zone manager is not a SAS device, the zone manager cannot be discovered by any of the other SAS devices, nor by the other zone managers running on the other switches. Thus, the typical zone managers may implement an arbitration process by communicating out-of-band, for example, over an Ethernet network. In this scenario, an additional software layer for the out-of band communication would be used, resulting in additional development and qualification time for developing the software layer. Furthermore, the switches would communicate over a public Ethernet network or a dedicated Ethernet network just for the SAS switches, resulting in additional system complexity.

Representing the SAS switch zone manager as a SAS-based end device connected to a virtual PHY on the SAS fabric enables existing SAS discovery and command functionality to be communicated between the zone managers in-band rather than using an out-of-band proprietary mechanism such as SAS over Ethernet. Thus, all zone managers running on each of the SAS switches can discover all of the other zone managers using in-band standards-based SAS discovery and communication mechanisms. This reduces both development costs and time to market and enables a highly scalable storage solution to be provided to users.

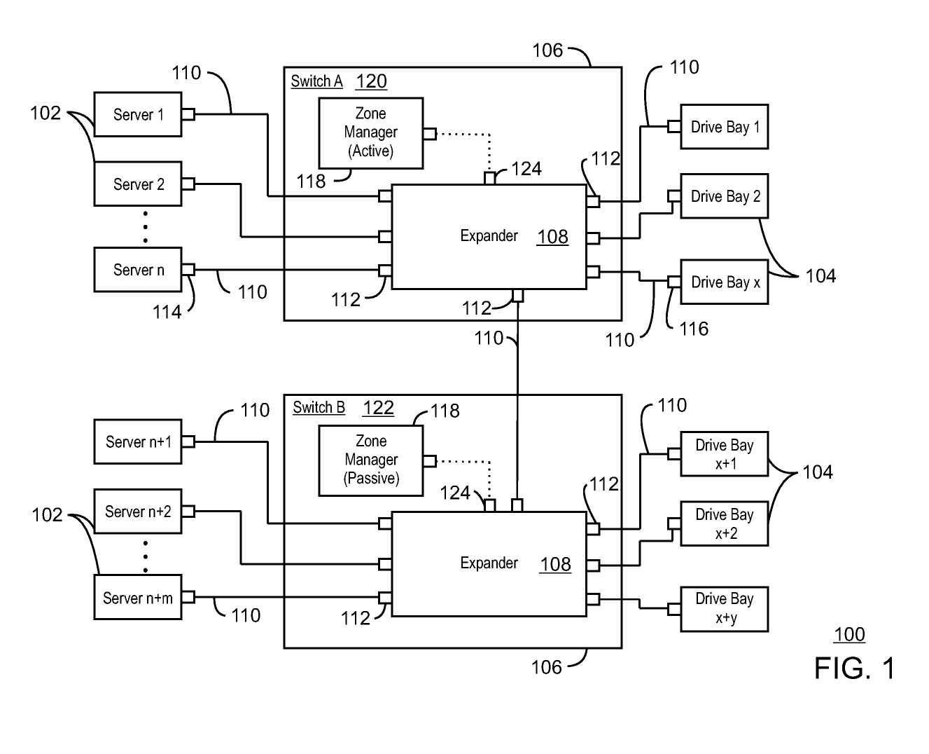

FIG. 1 is a block diagram of a DAS system in accordance with embodiments. The DAS system 100 may include one or more servers 102, each server 102 operatively coupled to one or more storage drive bays 104 which may or may not contain a storage drive, such as a disk drive, solid state drive, and the like. The servers 102 and the storage drive bays 104 may use the SAS protocol for connecting and transferring data. The DAS system 100 may also include one or more SAS switches 106 for coupling the servers 102 to the storage drive bays 104. In embodiments, the servers 102 and the switches 106 may be installed in a blade enclosure. For example, the blade enclosure may include one or more blade bays for receiving blade servers 102 and one or more interconnect bays for receiving the switches 106. In embodiments, the storage drive bays 104 may be included in a separate storage enclosure. Each server 102 may include a storage controller (not shown) for enabling the server 102 to access and communicate with the storage drives disposed in the storage drive bays 104. Each server's storage controller may be referred to as an initiator, and each storage drive may be referred to as a target.

Each switch 106 may include an expander 108 that controls the routing between the servers 102 and the storage drive bays 104. Each switch expander 108 may be coupled to one or more servers 102 and one or more storage drive bays 104 through physical interconnections 110, which may be cables or hardwired interconnections included in a storage or blade enclosure, for example. The two ends of a physical interconnection 110 are referred to herein as a port. The expander 108 may include a plurality of ports referred to herein as expander ports 112. Expander ports 112 may be coupled to server ports 114 and drive ports 116 through the physical interconnections 110. Each port 112, 114, and 116 may include one or more components commonly referred to as PHYs (not shown). A PHY is a physical layer transmitter/receiver pair for sending and receiving signals transmitted over the physical connections. As used herein, a port is a set of one or more PHYs that have the same SAS address. A SAS address is a unique identifier that can be assigned to each of the SAS components in the SAS fabric, for example, during system initialization. Each port can include a single PHY or multiple PHYs.

Each switch 106 may also include a zone manager 118 for configuring the switch's expander 108 by defining zone groups and assigning zone groups to specified servers 102. As used herein, the term zone group refers to a set of one or more storage drive bays 104 that can be assigned to one or more initiators. Zone groups can be assigned to initiators through the zone manager 118 according to a zoning configuration specified by the user. Commands may be sent from the zone manager 118 to configure the expander 108 such that a particular server 102 will be operatively coupled to one or more storage drive bays 104 specified by the user. In this way, the user may control the connectivity between the servers 102 and storage drive bays 104. The zone managers 118 may also be operatively coupled to a storage administration device through a TCP/IP network connection, for example. The storage administration device may be, for example, a general purpose computer that enables an administrator to configure the switches 106 remotely.

The PHYs of a single port are associated with a SAS address that is common to each PHY of the corresponding port. The SAS addresses may be determined at an initialization time and are unique to each port. Information about the state of the DAS system may be gathered by the zone manager 118 by querying the PHYs and receiving a response indicating the state of the PHY. For example, the response to a query may indicate whether the PHY is enabled, whether the PHY is attached to a SAS device, the type of device attached to the PHY, and the like. A query may be initiated by the administrator, and information corresponding to the query response may be sent back to the storage administration device and displayed. A query may also be initiated automatically in response to a change in the DAS system 100, for example, a new SAS device being added or removed from the DAS system 100.

In an embodiment, the switches 106 may be trunked. In other words, two or more switches 106 may be operatively coupled to one another for the purpose of increasing the number of expander ports 112 that can be used to couple the servers 102 to the storage drive bays 104. In the trunked configuration shown in FIG. 1, two switches 106, labeled “Switch A” 120 and “Switch B” 122 are coupled in a trunked configuration. As shown in FIG. 1, an expander port 112 of switch A 120 is coupled to an expander port 112 of switch B 122. The connection between the expander ports 112 of the two switches 106 enable any of the servers 102 to be zoned to any of the storage drive bays 104, regardless of whether the server 102 or the storage drive bay 104 is directly coupled to switch A 120 or switch B 122. Thus, the trunked switches 106 operate together as if they were a single switch. It will be appreciated that the configuration shown in FIG. 1 is but one example of a switch trunking configuration, as any number of switches 106 may be trunked together depending on the design details of a particular implementation. For example, switch B 122 could be further coupled to a switch C, which could be coupled to a switch D, and so on. In embodiments, a single switch 106 could be coupled to three or more switches 106. Furthermore, the present techniques are not limited to DAS systems with trunked switches, as embodiments may also include DAS systems with one switch 106 or multiple non-trunked switches 106.

When two or more switches are trunked together as shown in FIG. 1, one of the zone managers 118 can control the zoning configuration of the DAS system 100. Thus, a single zone manager 118 may be active, while all other zone managers 118 may be passive. In the example shown in FIG. 1, the zone manager 118 of switch A 120 is active, and the zone manager 118 of switch B 122 is passive. An inter-switch arbitration process between the zone managers may be implemented to enable the zone manager 118 of switch A 120 to establish control over the zoning operations implemented in the DAS system 100. In an embodiment, the zoning configuration implemented by the active zone manager 118 of switch A 120 may be communicated to the passive zone manager 118 of switch B 122. In this way, the passive zone manager 118 of switch B 122 can become the active zone manager in the event that the zone manager 118 of switch A 120 goes offline or otherwise becomes inoperable.

As described above, each of the zone managers 118 may be implemented using a zone manager virtual PHY 124 on each SAS switch expander 108. To implement the zone manager virtual PHY 124, the zone manager 118 may be assigned a unique SAS address so that the zone manager 118 appears as a unique SAS device in the DAS system 100. The zone manager 118 may be operatively coupled to the corresponding expander 108 using a communication interface such as an Ethernet interface, universal asynchronous receiver/transmitter (UART) serial connection, Inter-Integrated Circuit (I2C), or any other type or communication protocol. If the zone manager is implemented as a function of the SAS switch expander, data may be transferred via internal buffers and callbacks. Each switch expander 108 may implement a bridge function between the virtual PHY and the Ethernet interface to which the zone manager 118 is connected. To implement the bridge function, SAS-based commands received by the expander 108 targeting the SAS address of the zone manager 118 may be converted to Ethernet packets and sent to the zone manager 118. Similarly, SAS commands received by the expander 108 from the zone manager 118 over Ethernet may be converted from Ethernet packets into corresponding SAS-based commands and transmitted over the SAS fabric by the expander 108. In this way, each of the zone managers 118 appears as a SAS end device. Thus, the inter-switch arbitration between the zone managers 118 may be implemented using SAS-based commands.

Each expander 108 may determine the topology of the DAS system 100 by issuing SAS-based commands such as the REPORT GENERAL, DISCOVER, DISCOVER LIST, and INQUIRY commands. The REPORT GENERAL command may be used to report general information about each expander such as the number of PHYs, and other expander attributes. When the zone manager 118 is configured as an end device connected to a virtual PHY in the SAS switch expander 108, an additional PHY corresponding to the zone manager 118 may be reported in the NUMBER OF PHYS field in the REPORT GENERAL command.

The DISCOVER, and DISCOVER LIST commands may be used to report a routing attribute for each expander PHY. The DISCOVER command may be used to query one or more specific PHYs, which are specified within the command. The DISCOVER LIST command may be used to query all of the PHYs associated with the switch 106. The DISCOVER and DISCOVER LIST commands may be initiated by the zone manager 118. A response to the DISCOVER or DISCOVER LIST commands may be generated by the expander 108 and sent back to the corresponding zone manager 118. The response may include an indication regarding whether the PHY or PHYs are in a linked-up state. For example, the response to the DISCOVER or DISCOVER LIST commands may include an “ATTACHED DEVICE TYPE” field for each associated PHY. A value of 0 in the ATTACHED DEVICE TYPE field may indicate no device is physically linked up to the corresponding PHY. An INQUIRY command may be used to acquire additional information about the device attached to a specific PHY.

When a DISCOVER or DISCOVER LIST command is sent to the virtual PHY of the zone manager or switch expander, the VIRTUAL PHY field of the DISCOVER response may be set to 1, which indicates that the expander 108 includes a virtual PHY. In response to the DISCOVER command, the zone manager may publish itself as both a Serial SCSI protocol (SSP) target and a SSP and Serial Management Protocol (SMP) initiator. Upon receiving an INQUIRY command, the zone manager 118 may identify itself as a Security manager device in the peripheral device type field of the INQUIRY command response. In this way, the zone manager 118 attached to one of the SAS switches 106 can discover all other zone managers 118 attached to other SAS switches 106 using SAS discovery code implemented in each of the zone managers 118. This enables the zone managers 118 to discover other zone managers 118 for establishing active and passive zone management roles. The zoning configuration maintained by the active zone manager of switch A 120 can be transferred to the passive zone manager 118 of switch B 122 and any other zone managers 118 in the DAS system 100 using WRITE BUFFER commands. The passive zone managers 118 provide increased redundancy and failover capability. Implementing the zone manager on a virtual PHY also enables the zone manager to be discovered by initiators such as storage controllers residing on the servers 102. In this way, the storage controllers can communicate directly with the SAS switch 106 zone managers 118 using in-band SAS protocol commands and functions.

Certain events occurring with the DAS system 100 may be transmitted to SAS initiators using SAS functions known as broadcasts. A “change” broadcast may be originated by one of the expanders 108 to notify the initiators that a change has occurred in the DAS system 100. For example, if a storage drive disposed in one of the storage drive bays 104 is disconnected or otherwise goes offline, the expander 108 coupled to that storage drive bay 104 may generate a BROADCAST (CHANGE) event informing the initiators that the storage drive is no longer linked up. To maintain the zone manager appearing as a true SAS device connected to the DAS system 100, a heartbeat may be established between the switch expander 108 and the zone manager 118. As an example, if the connection between the zone manager 118 and the switch expander 108 is Ethernet, the heartbeat could be a TCP packet sent from the zone manager to the switch expander 108 at regular intervals, for example, every n seconds. The link state of the virtual PHY will correlate to the TCP connection state and the heartbeat state between the expander 108 and the zone manager 118 over Ethernet. Standard SAS constructs such as BROADCAST (CHANGE) events can be propagated by the switch expander 108 to the rest of the DAS system 100 when the zone manager's state changes because of a heartbeat failure. For example, a heartbeat failure could occur due to a zone manager reset, which may take place after a firmware update and enables the new firmware to take effect.

To initiate communications with a SAS end device such as a storage drive, an initiator, such as a storage controller, may send a request, known as an OPEN ADDRESS frame, to one of the expanders 108. The OPEN ADDRESS frame includes a source address of the initiator and a target SAS address of the SAS end device. The expander routes the OPEN ADDRESS frame to the target SAS device identified by the OPEN ADDRESS frame. Upon receiving the OPEN ADDRESS frame, the target and the initiator may establish a connection. When the zone manager 118 communicates with any other SAS device in the DAS system 100, the expander 108 may set the source address of the OPEN ADDRESS frame to that of the zone manager 118.

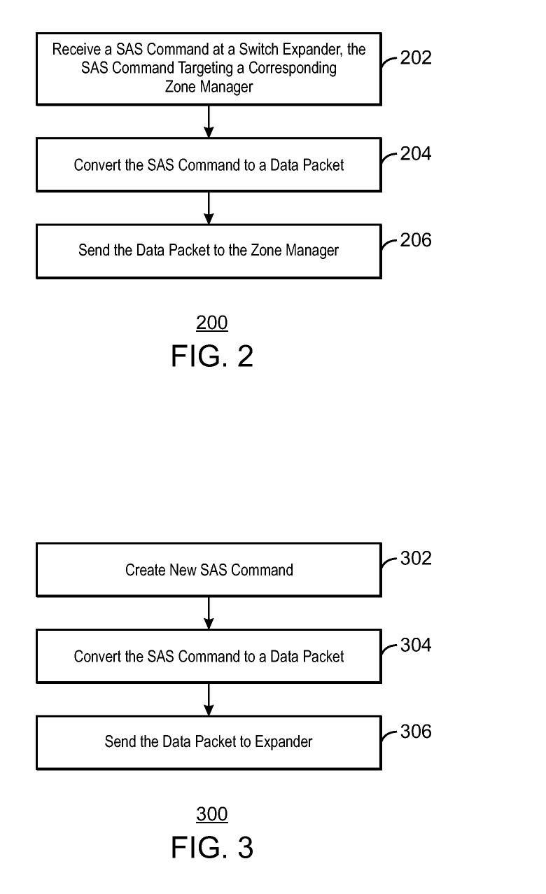

FIG. 2 is a process flow diagram of a method of operating a zone manager virtual PHY in accordance with embodiments. The method 200 may be performed by the switch expanders 108 shown in FIG. 1. The method 200 may begin at block 202, wherein a SAS command is received at a switch expander 108. The SAS command may target the switch's zone manager 118 by referencing the zone manager's assigned SAS address. The zone manager 118 may be assigned a unique SAS address during an initialization stage. The command may be any suitable type of SAS-based command or function, such as an INQUIRY command, WRITE BUFFER command, or BROADCAST event, among others. In an embodiment, the SAS command may be received from a storage controller residing one of the servers 102, a zone manager 118 of a different switch 106, another expander 108, or any other SAS device in the DAS system 100.

At block 204, upon determining that the SAS command is intended for the zone manager 118, the expander 108 converts the SAS command to a data packet such as an Ethernet packet or other type of data packet in accordance with the applicable communication protocol used between the zone manager and the expander. At block 206, the expander 108 sends the data packet to the zone manager 118 over the connection coupling the expander 108 to the zone manager 118. The zone manager 118 receives and processes the SAS command. For example, if the SAS command is a WRITE BUFFER command configured to transfer the zoning configuration to the zone manager 118, the zone manager 118 may store the zoning configuration to a memory maintained within the switch 106. If the SAS command is an INQUIRY command, the zone manager 118 may send an INQUIRY response back to the requesting device identifying itself as a security manager device as described above.

FIG. 3 is a process flow diagram of a method of operating a zone manager virtual PHY in accordance with embodiments. The method 300 may be performed by the zone managers 118 shown in FIG. 1 and enables each zone manager 118 to act as an SSP initiator and send SAS commands to the devices on the fabric. The method 300 may begin at block 302, wherein the zone manager creates a new SAS command targeting a SAS device in the DAS system 100. The SAS command may be any suitable type of SAS-based command or function, such as an INQUIRY command, WRITE BUFFER command, or BROADCAST event, among others.

At block 304, the zone manager 118 converts the SAS command to a data packet such as an Ethernet packet or other type of data packet in accordance with the applicable communication protocol used between the zone manager and the expander. At block 306, the zone manager 118 sends the data packet to the expander 108 over the connection coupling the zone manager 118 to the expander 108. The expander 108 receives the data packet and extracts the SAS command from the data packet. The expander 108 adds the SAS address of the zone manager 118 to the SAS command as the source address in the OPEN ADDRESS frame of the SAS command. The expander then routes the SAS command to the targeted device on the fabric. In an embodiment, the SAS command may target a storage controller residing one of the servers 102, a zone manager 118 of a different switch 106, another expander 108, or any other SAS device in the DAS system 100.

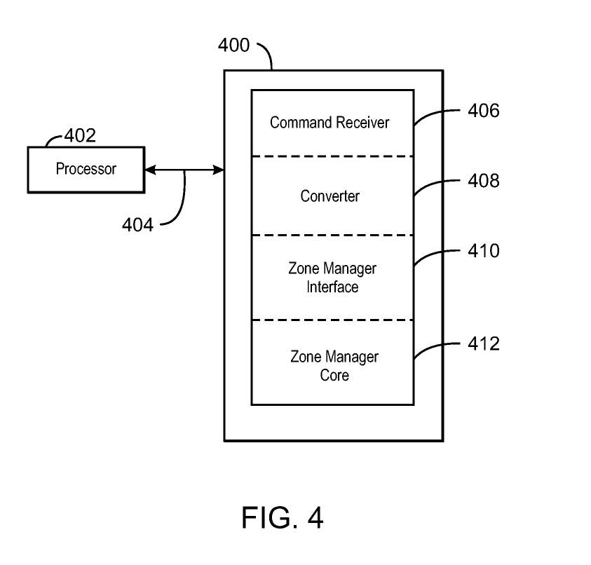

FIG. 4 is a block diagram showing a non-transitory, computer-readable medium that stores code for operating a zone manager virtual PHY in accordance with embodiments. The non-transitory, computer-readable medium is generally referred to by the reference number 400 and may be included in one or more of the switches 106 of the DAS system 100 described in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate the zone manager virtual PHY in accordance with embodiments. In an embodiment, the tangible, machine-readable medium 400 can be accessed by the processor 402 over a bus 404. A first region 406 of the non-transitory, computer-readable medium 400 may include a command receiver configured to receive a SAS command from a SAS device. A second region 408 of the non-transitory, computer-readable medium 400 may include a converter configured to translate the SAS command into a data packet such as an Ethernet packet and vice versa. A third region 410 of the non-transitory, computer-readable medium 400 may include a zone manager interface configured to send the data packet to a zone manager over the communications interface. A fourth region 412 may include a zone manager core configured to create and manage the zones in the entire fabric.

Although shown as contiguous blocks, the software components can be stored in any order or configuration. For example, if the non-transitory, computer-readable medium 400 is a hard drive, the software components can be stored in non-contiguous, or even overlapping, sectors.

1. A switch comprising:
an expander configured to couple a server to a set of storage drive bays over an interconnection network, wherein the server and the storage bays communicate according to a first communication protocol; and
a zone manager coupled to the expander and configured to maintain a zoning configuration corresponding to the set of storage drive bays, wherein the zone manager is coupled to the expander through a virtual PHY and communicates with the expander according to a second communication protocol different from the first communication protocol;
wherein commands sent through the virtual PHY are translated by the expander between the first communication protocol and the second communication protocol.

2. The switch of claim 1, wherein the zone manager has a corresponding SAS address.

3. The switch of claim 1, wherein the second communication protocol is one of an Ethernet protocol, a universal asynchronous receiver/transmitter (UART) protocol, and an Inter-Integrated Circuit (I2C) protocol.

4. The switch of claim 1, wherein the expander is configured to receive a SAS command in accordance with the first communication protocol and targeting the zone manager, convert the SAS command to a data packet in accordance with the second protocol, and send the data packet to the zone manager.

5. The switch of claim 1, wherein the zone manager is configured to generate a SAS command addressed to a destination device, convert the SAS command into a data packet in accordance with the second communication protocol, and send the data packet to the expander for delivery to the destination device in accordance with the first communication protocol.

6. The switch of claim 1, wherein the zone manager is discoverable by other SAS devices using a DISCOVER or DISCOVER LIST command.

7. The switch of claim 1, wherein the zone manager periodically sends a heartbeat signal to the expander, wherein if the expander fails to receive the heartbeat signal, the expander generates a broadcast event configured to alert other SAS devices that the zone manager is offline.

8. A system comprising:
a set of storage drive bays; and
a server configured to communicate with the set of storage drive bays over an interconnection network according to a first communication protocol, the interconnection network comprising a first switch comprising:
a first expander configured to couple the server to the set of storage drive bays; and
a first zone manager coupled to the first expander and configured to maintain a zoning configuration corresponding to the set of storage drive bays, wherein the first zone manager is coupled to the first expander through a first virtual PHY and communicates with the first expander according to a second communication protocol;
wherein commands sent through the virtual PHY are translated by the expander between the first communications protocol and the second communication protocol.

9. The system of claim 8, wherein the first switch is operatively coupled to a second switch comprising:
a second expander configured to couple the server to the set of storage drive bays; and
a second zone manager coupled to the second expander and configured to maintain the zoning configuration corresponding to the set of storage drive bays, wherein the second zone manager is coupled to the second expander through a second virtual PHY.

10. The system of claim 9, wherein the first zone manager maintains active control over zoning operations and the second zone manager receives the zoning configuration from the first zone manager.

11. The system of claim 9, wherein the first zone manager and the second zone manager communicate through the first switch and the second switch using SAS-based commands.

12. The system of claim 9, wherein the first zone manager periodically sends a heartbeat signal to the first expander, wherein if the first expander fails to receive the heartbeat signal from the first zone manager, the second zone manager takes active control over zoning operations.

13. The system of claim 8, wherein the first expander is configured to receive a SAS command targeting the first zone manager, convert the SAS command to a data packet in accordance with the second communication protocol, and send the data packet to the first zone manager.

14. The system of claim 8, wherein the first switch is one of a plurality of switches operatively coupled to one another in a trunking configuration and configured to couple the server to the set of storage drive bays.

15. A method comprising:
receiving a SAS command at a switch expander, wherein the SAS command is in accordance with a SAS protocol and is targeting a corresponding zone manager associated with a SAS address;
converting the SAS command to a data packet in accordance with a second protocol different from the SAS protocol; and
sending the data packet to the zone manager.

16. The method of claim 15, comprising:
receiving a second data packet from the zone manager, wherein the second data packet is in accordance with the second protocol and contains a second SAS command targeting a SAS device;
converting the second data packet to the second SAS command in accordance with the SAS protocol; and
sending the second SAS command to the SAS device.

17. The method of claim 15, wherein the zone manager is passive and the SAS command is a WRITE BUFFER command received from an active zone manager, the WRITE BUFFER command configured to transfer the zoning configuration to the zone manager.

18. The method of claim 15, wherein the SAS command is an INQUIRY command and, in response to INQUIRY command, the zone manager identifies itself as a security manager device.

19. The method of claim 15, wherein the SAS command is an SMP DISCOVER command and, in response to the SMP DISCOVER command, the expander identifies the zone manager attached to a virtual PHY as an SSP Initiator and SSP Target.

20. The method of claim 15, wherein the SAS command is received from a storage controller on the server.
